(19) United States
(12) Patent Application Publication
(10) Pub. No.: US 2022/0215774 A1
(43) Pub. Date: Jul. 7, 2022

(54) SYSTEM AND METHOD FOR ELECTRONIC TEXT DISPLAY

(71) Applicant: Basil GENESIS, Moscow (RU)

(72) Inventor: Basil GENESIS, Moscow (RU)

(21) Appl. No.: 17/700,438

(22) Filed: Mar. 21, 2022

Related U.S. Application Data
(63) Continuation-in-part of application No. 17/498,056, filed on Oct. 11, 2021.
(60) Provisional application No. 63/091,081, filed on Oct. 13, 2020.

(51) Int. Cl. G09B 19/06; G09B 5/06

(52) U.S. Cl. CPC G09B 19/06; G09B 5/06

(57) ABSTRACT

The invention is a complete electronic display solution which allows a reader/user to learn and examine unfamiliar terminology while reading and without requiring the act of accessing additional outside resources. The invention automatically systematizes data obtained during the reading process while allowing the user to customize the data displayed adjacent to unknown terms, thereby increasing the efficiency of the reader's perception of such unfamiliar words, phrases, or sentences. The display involves both simplified and advanced informative displays, modules for managing the explanatory data provided, user interactivity features within the display, and multifunctional tools and buttons. The user is therefore able to not only intensively analyze complex grammatical constructions as desired but also to enjoy reading various literature in a less familiar language, all within the area of a single device screen.

### CROSS-REFERENCE TO RELATED APPLICATIONS

This patent application in a Continuation-in-Part of U.S. patent application Ser. No. 17/498,056, filed Oct. 11, 2021, which claims priority to U.S. Provisional Patent Ser. No. 63/091,081, filed Oct. 13, 2020, all of which are incorporated herein by reference in their entireties.

### FIELD OF THE INVENTION

This invention relates to electronic text displays and methods or systems for electronic text displays which facilitate learning vocabulary in context and while reading without the need for secondary resources.

### BACKGROUND OF THE INVENTION

Between reading and the cognitive capabilities of a person, there is a clear relationship that allows you to develop creativity and imagery of thinking. High-quality literature allows you to diversify speech with new words and expressions, which are almost impossible to meet in everyday life. Reading provides the fastest build-up of the intellectual base of a person, as well as a reduction of emotional stress and increase in inner harmony. Therefore, reading is one of the most important fundamental skills, which is an integral part of the educational process, especially if it concerns the study of foreign languages.

Those individuals learning foreign languages in the world can be divided into two groups of people.

The first group is local or international students who constantly experience difficulties in obtaining education when it involves reading literature in a language other than their native language.

The second group is not students but those who have set themselves with the task of learning one or more foreign languages, and the main problem they face is the inability to start reading books in a foreign language from the very beginning of their studies.

One problem unites these two groups—a low level of vocabulary, which turns the reading process into a battle with the learning material.

International students are particularly uncomfortable, as practicing reading is the most effective way for them to learn to speak fluently, but the lack of reading skills puts them in an unprivileged position compared to native speakers. This situation practically destroys any attempts for social integration, since it often leads to irritation and complexity in students of non-native speakers of the language, and as a result, the learning process suffers. It does not matter how well the curriculum is adapted to international students, as the practice of reading greatly limits it. It is very difficult to imagine the study of foreign languages without the possibility of reading outstanding representatives of these languages in the original language. Therefore, many teachers are unable to provide successful reading programs because non-native students simply cannot complete them.

For an international student to fully comprehend the educational process, there are only two practices of reading in a foreign language—intensive and extensive reading.

Intensive reading is a type of class reading and implies a detailed reading of short fragments of text to obtain specific information. Intensive reading is important for understanding every word in the text, understanding sentence structure, semantics, and also for focusing on grammar.

Extensive reading is extracurricular reading and is used to gain a general understanding of the subject and involves reading long texts for pleasure using a relatively small vocabulary. With extensive reading, it is important to understand not each word separately, but to be able to comprehend the general meaning of the words in context.

Both types of reading cause fear in non-native students, since vocabulary in both cases is a fundamental circumstance to read and speak a foreign language fluently, and reading is the only effective method for acquiring vocabulary. Therefore, international students are constantly faced with such a contradiction in education, and at the same time, there are no serious tools that will allow them to read freely in a foreign language in educational programs.

Even though, at the moment, there are a large number of software tools that make it possible to facilitate the process of reading foreign literature, the methods that are used in these tools are not comfortable for achieving a large vocabulary in a short time. In all these applications, the reader must perform a number of tedious actions while reading books such as: copying or writing unfamiliar terms, actively working with the dictionary, or working with flash cards to study a set of words. The next time the reader encounters an unfamiliar word in the text, he is again forced to turn to the dictionary, and as a result, the reading process turns into an irritable routine that one desires to avoid.

Also, the student does not have the opportunity to choose to read foreign literature according to his level of training or desire, since all the assistants presented to date for reading foreign literature do not give the opportunity to choose literature, but only use books prepared in advance. And it is important to note that none of the existing tools can be considered as a professional means for learning a foreign language through reading, since they are very limited in their capabilities, and therefore, no university recognizes them as a full-fledged tool that can get rid of the discomfort of many international students in mastering foreign literature.

Therefore, at the moment, there is no universal means for reading any foreign literature that would allow one to work comfortably with the text and would contribute to an active increase in vocabulary. As a result, there is a need for an electronic display tool that would allow becoming part of the educational process not only for international students, but also would help other groups of people to gain comfortable access to any foreign literature without needing to access any secondary resources, such as, but not limited to, a dictionary.

### SUMMARY OF THE INVENTION

The present invention is aimed at significantly facilitating the process of learning foreign languages through reading and increases the level of understanding of text material several times in comparison with other existing practices.

This invention allows for one to combine intensive and extensive reading, and as a result, the level of vocabulary of the user increases several times after reading at least one book.

This invention allows one to avoid unnecessary and time-consuming actions with regard to the text, as it automatically translates within the text any words, phrases, grammatical constructions, idioms, etc.

It is sufficient for the user to add an unfamiliar text term to the database only once, and its meaning will constantly and automatically be provided every time this term is encountered in the text.

This invention allows one to study all unfamiliar text terms in the context of the sentence, without being distracted by working with additional dictionaries, thereby increasing the efficiency of perception of unfamiliar information. The user can not only intensively analyze complex grammatical constructions, but also enjoy reading literature in an unfamiliar language.

The present invention illustrates an example of a complete solution which allows one to study all unfamiliar text terms in the context of a sentence, as well as automatically systematize the data obtained during the reading process without being distracted by additional dictionaries, thereby increasing the efficiency of perception of unfamiliar information. The present invention is built on the original user interface and logical rules that are part of the original software. The user is able to not only intensively analyze complex grammatical constructions, but also enjoy reading literature in an unfamiliar language.

### BRIEF DESCRIPTION OF THE DRAWINGS

The invention is illustrated by the following diagrams.

FIGS. 1A and 1B illustrate how to manage unknown terms and meanings of those terms to the user database via the multifunctional module of the invention.

FIGS. 2A-2E illustrate the interactive features of the meanings bars which appear above unknown terms in the text, as well as examples of the logical rules on the basis of which meanings and unknown terms appear in the display.

### DETAILED DESCRIPTION OF THE PREFERRED EMBODIMENTS

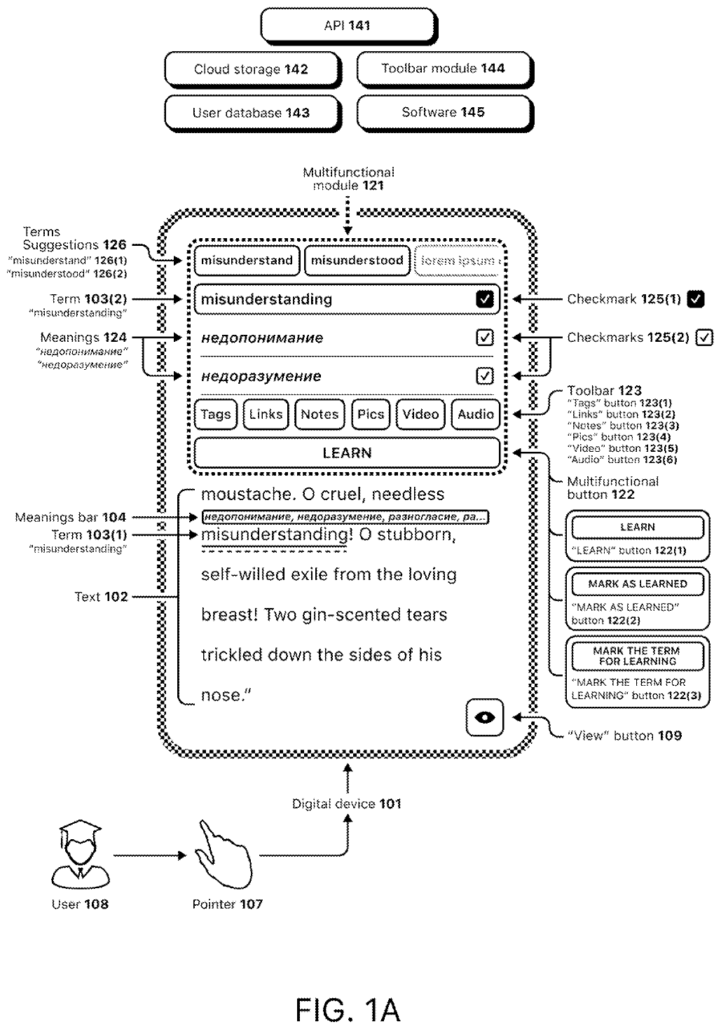

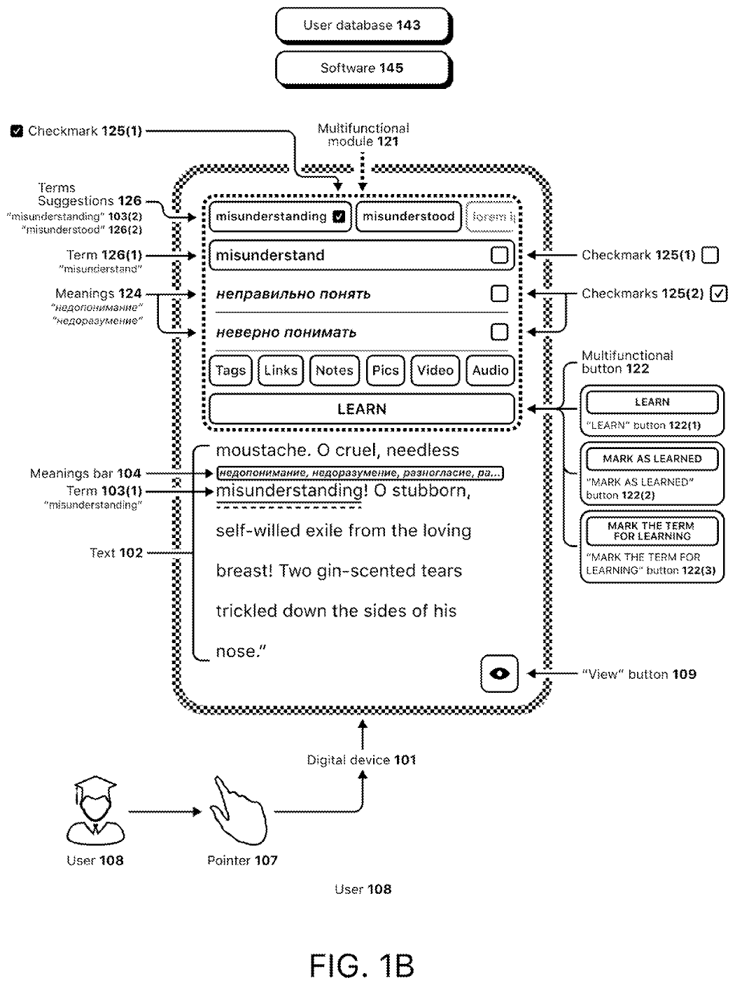

The list of elements depicted in FIGS. 1A and 1B is as follows:

The digital device 101 is a computer or mobile device with a display.

The text 102 is any kind of electronic text that can be displayed by the digital device 101.

The term(s) 103(1), 103(2) comprise any word, phrase, or sentence in the text that is selected by a user via the pointer 107 (see 103(1)) or which is displayed (as a copy of the term) in the multifunctional module 121 (see 103(2)).

The meanings bar 104 is an interactive panel with text or other symbols that appears above any term chosen by the user within the text. The main task of the meanings bar 104 is to provide explanatory information, including but not limited to definitions, for the unfamiliar terms in the text in either the native or a non-native language. The explanatory information provided in the meanings bar 104 is managed by the user via the multifunctional module 121.

The pointer 107 may comprise a human finger, an electronic pen, a stylus, a mouse cursor, or other device utilized by the user for selecting objects or interacting with objects on the screen of the digital device 101. The screen may be, for example, a touch screen, a laser-sensing screen, a part of a gesture reader system, or a part of a virtual reality system.

The user 108 is a person who is utilizing the display to learn and/or read.

The “View” button 109 is a button that allows the user to display (or hide) the meanings bars 104 in the text 102.

The multifunctional module 121 is a module which is displayed in the form of a pop-up window, page, or other element of the screen of the digital device 101. The multifunctional module 121 appears when the API 141 responds in reply to the user selecting a term.

The multifunctional button 122 is a multifunctional button located inside the multifunctional module 121, which can change its display depending on the scenario and the user's desire with regard to the term being managed.

The toolbar 123 and the toolbar buttons 123(1)-123(6) comprise a special panel inside the multifunctional module 121, which allows a user to add additional information to the meanings bar 104 corresponding to the term being managed.

The meanings 124 comprise explanatory information, including but not limited to definitions and examples of use, for the term being managed in the multifunctional module 121 in the user's native language or in a non-native language.

The checkmarks 125(1), 125(2) comprise checkboxes inside the multifunctional module 121, which allow a user to manage data by selecting or unselecting data provided from a database and related to the term.

The term suggestions 126, 126(1)-126(2) are terms provided within the multifunctional module 121 that are closely related, by morphological or other features, to the term being managed.

The API 141 is an application programming interface, which is a software intermediary that allows two applications to talk to each other. The API provides a connection between the software of the display and the databases issuing the meanings 124 for a term 103(1), 103(2). Databases are provided by various companies that are engaged in the creation of their own databases in the field of formation of, e.g., electronic dictionary entries. The API 141 supplies various kinds of data such as but not limited to: meanings of terms in a native or non-native language, definitions for terms in a native or non-native language, suggested terms (i.e., terms that are closely related by morphological features to the term selected in the text), examples of the use of a term in context, and other information related to the term.

The user database 143 is a database that is generated by the user 108 inside the specialized software 145 and which can be stored both on the digital device 101 and in cloud storage 142.

The toolbar module 144 is a module in the form of a pop-up window, page, or other element of the screen of a digital device 101, which is called when the user is interacting with the toolbar buttons 123(1)-123(6).

The software 145 is a specialized software through which the user database 143 and the text 102 are inextricably linked by a set of rules.

In order to understand how this invention works, it is necessary to describe the general method of approaching the existing task that has developed in the world. A user learning a foreign language needs to obtain meanings for unfamiliar terms that he encounters when reading literature in a language that is not native to him. The generally accepted practice in the world uses a method in which the user selects unfamiliar terms in any readable text, after which a request is made to an API, which in turn provides meanings for unfamiliar terms in the form of a small, pop-up window with low informativeness and limited functionality. In such a case, the user has two choices for learning unfamiliar terms:

(1) Add the suggested meanings to a database and continue to study them in various ways, likely interrupting the reading mode, since it is impossible to do this directly in the text; or

(2) Without interrupting the reading mode, selecting each unfamiliar term in the text to retrieve its meaning.

Both of the above methods are ineffective.

FIGS. 1A and 1B illustrate the method of the present invention for adding the unfamiliar term 103(1) selected in the text 102, as well as any additional suggested terms 126 to the user database 143.

The present invention offers an original approach that allows the user to learn any unfamiliar terms that occur in the electronic text without having to leave the electronic text area and without needing to access additional resources.

When the user 108, using the pointer 107, selects the term 103(1), a request is made to retrieve all possible meanings for the term 103(1) to the external API 141. After the response from the API 141 is received, the multifunctional module 121 appears on the display. Simultaneously with the appearance of the multifunctional module 121, the meanings bar 104 appears above the term 103(1) in the text 102 of the display. The multifunctional module 121 appears on the display each time the user 108 selects any term in the text 102. Using the pointer 107 the user can select an unlimited number of terms in the text at the same time. In such a case, all the selected terms are combined into one term to send a request to the external API 141.

The multifunctional module 121 displays a copy 103(2) of the selected term 103(1), and below the copy 103(2), it displays the meanings 124 for the term, the suggested terms 126, the toolbar 123, and the multifunctional button 122. All data provided by the multifunctional module 121 is intended to be selectable such that the user may manage the information from the multifunctional module 121 as displayed in the meanings bar 104. The meanings bar 104 itself also has interactive functionality, as described further below.

FIG. 1A illustrates receiving a response from API 141, where each selected term, with its meanings 124, is provided and automatically marked with the checkmarks 125(1) and 125(2) within the multifunctional module 121. The multifunctional button 122 will display “LEARN” as the initial option for selection (i.e., “learn” button). This means that the term 103(2) is ready to be learned. If the user presses the “LEARN” button 122(1), the software 145 will add the term 103(2), with its selected meanings 124, to the user database 143. If the user unchecks the term's checkmark 125(1), all meanings checkmarks 125(2) will be automatically unchecked. In addition, the display of the multifunctional button 122 will automatically change to display, “MARK THE TERM FOR LEARNING” 122(3) (i.e., “re-learn” button). This notifies the user that the term 103(2), with its meanings 124, cannot be added to the user database 143 until it is marked with a checkmark 125(1). Also, when the user unchecks the term's checkmark 125(1), the meanings bar 104 above the term 103(1) in the text 102 will also disappear. Thus, only those terms 103(2) that are marked with the term checkmark 125(1) are added to the user database 143 after tapping the “LEARN” button 122(1).

The term 103(2) can have multiple meanings 124. If the user unchecks all meanings checkmarks 125(2), this will also automatically uncheck the term checkmark 125(1), which, similarly, will also change the label on the multifunctional button 122 to “MARK THE TERM FOR LEARNING” 122(3). If the user ignores this message, the term 103(2), with its meanings 124, will not be added to the user database 143. If the user unchecks all meanings checkboxes 125(2), the meanings bar 104 above the term 103(1) in the text 102 will, similarly, also disappear.

Each copy 103(2) of the term 103(1) selected in the text 102, may have a different number of suggested terms 126 depending on its significance in a particular foreign language. The suggested terms 126 comprise separate ribbon buttons that the user can interact with to provide meanings within the multifunctional module 121. The suggested terms 126 may scroll left or right if they do not fit in the display of the multifunctional module 121.

FIG. 1B illustrates the selection of one of the suggested terms 126(1) using the pointer 107 in order to obtain the meanings 124 for the suggested term 126(1). Prior to this, the term 126(1) was among the suggested terms 126, as seen in FIG. 1A, but after it is selected, the original term 103(2) and the suggested term 126(1) are switched. As shown, the suggested term 126(1) is not automatically or initially marked with a checkmark 125(1); therefore, it cannot be added to the database 143 for study. FIG. 1B shows that among all the terms 103(2), 126(1), 126(2), which are in the multifunctional module 121, only one term 103(2) will be sent to the database 143, when the user taps the “LEARN” button 122(1), since only it is marked with the checkmark 125(1).

After tapping the “LEARN” button 122(1), the multifunctional module 121 may disappear, collapse, or go into another state that does not interfere with the reading of the text, but, over the selected term 103(1) in the text 102, the meanings bar 104 remains, since this term was added to the database 143. At this point, if the user once again taps the selected term 103(1) in the text 102, the multifunctional module 121 will reappear but the multifunctional button 122 will display the option to “MARK AS LEARNED” 122(2) (i.e., “learned” button), since the term is already in the database 143.

If the user taps on the “MARK AS LEARNED” button 122(2), the term 103(1) is marked in the database 143 as learned, and, above the selected term 103(1) in the text 102, the meanings bar 104 will no longer appear. If the user re-selects the already learned term 103(1) in the text 102, the multifunctional module 121 will reappear but the multifunctional button 122 will once again display the option to “LEARN” 122(1) the term. If the user taps this button, the meanings bar 104 will reappear above the selected term in the text. If any term has already been added to the database 143 once, the meanings bar 104 will reappear above it. Thus, the user has constant control over the terms that are added to the database 143, and the meanings bars 104 displayed above those terms, and the user can learn these terms without leaving the text. The user may also control the display of all meanings bars 104 using the view button 109. Tapping the view button 109 allows for all meanings bars 104 to be displayed or not displayed within the text.

In FIGS. 1A and 1B, the multifunctional module 121 also contains a toolbar 123, consisting of several elements:
the “Tags” button 123(1) allows the user to add tags to the selected term in the text.
the “Links” button 123(2) allows the user to link different terms with one another.
the “Notes” button 123(3) allows the user to add notes to the selected term in the text.
the “Pictures” button 123(4) allows the user to add pictures to the selected term in the text.
the “Video” button 123(5) allows the user to add video to the selected term in the text.
the “Audio” button 123(6) allows the user to add audio to the selected term in the text.

Each time a user 108 interacts with any of the buttons on the toolbar 123, the toolbar module 144 is accessed, via which the user can add additional information to the selected term. As this information is added via the multifunctional module 122, it will also appear inside the meanings bar 104, located above the term 103(1) in the text 102.

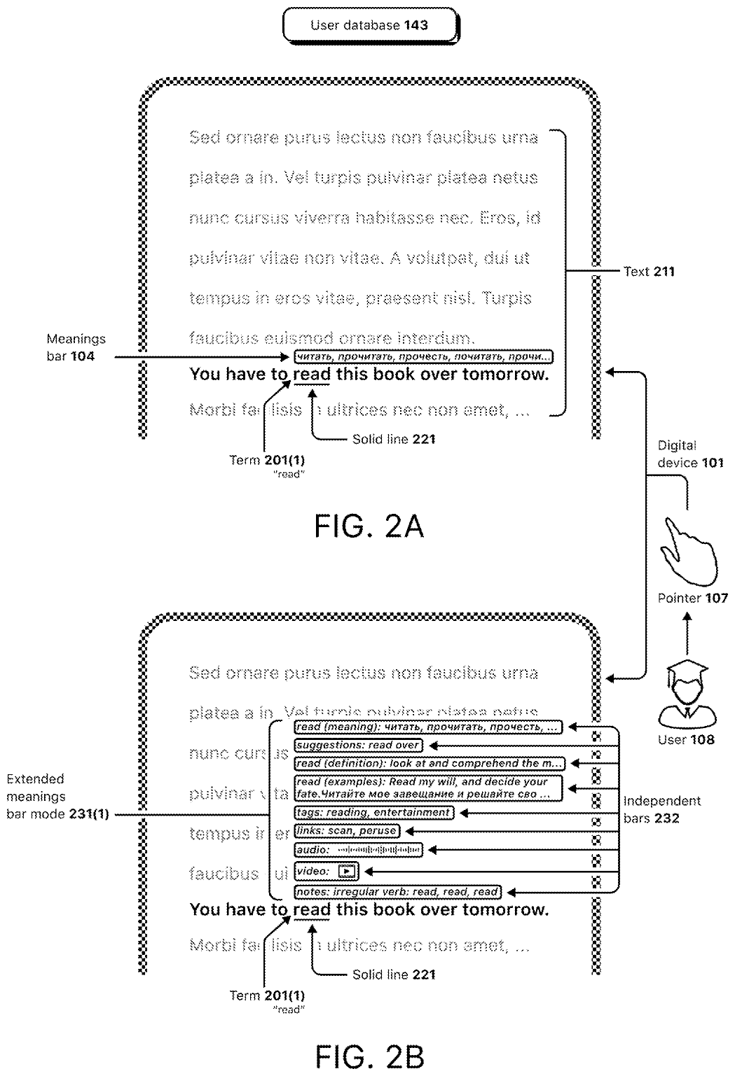

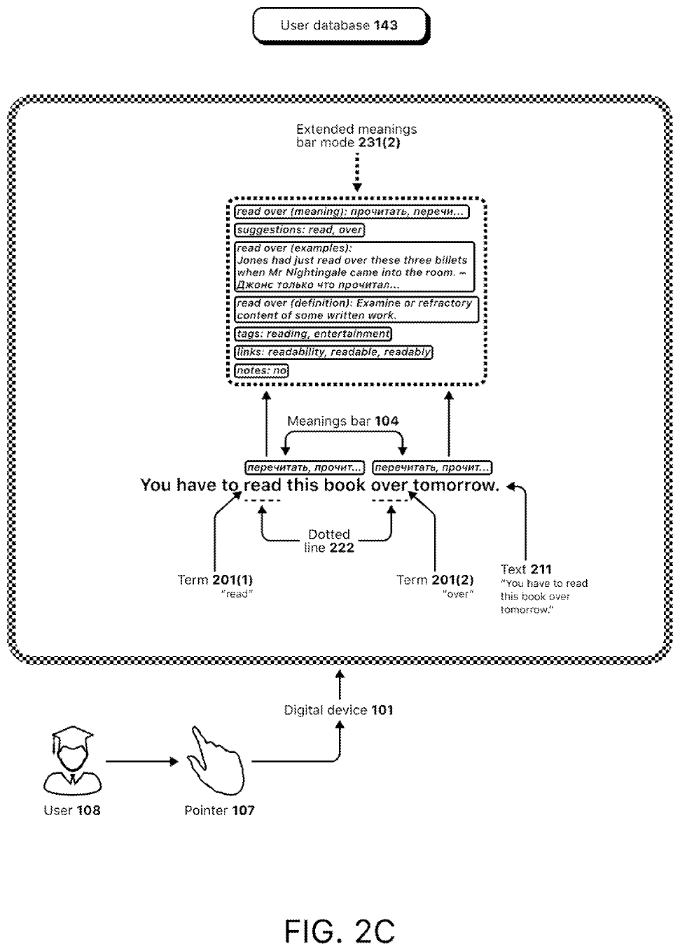

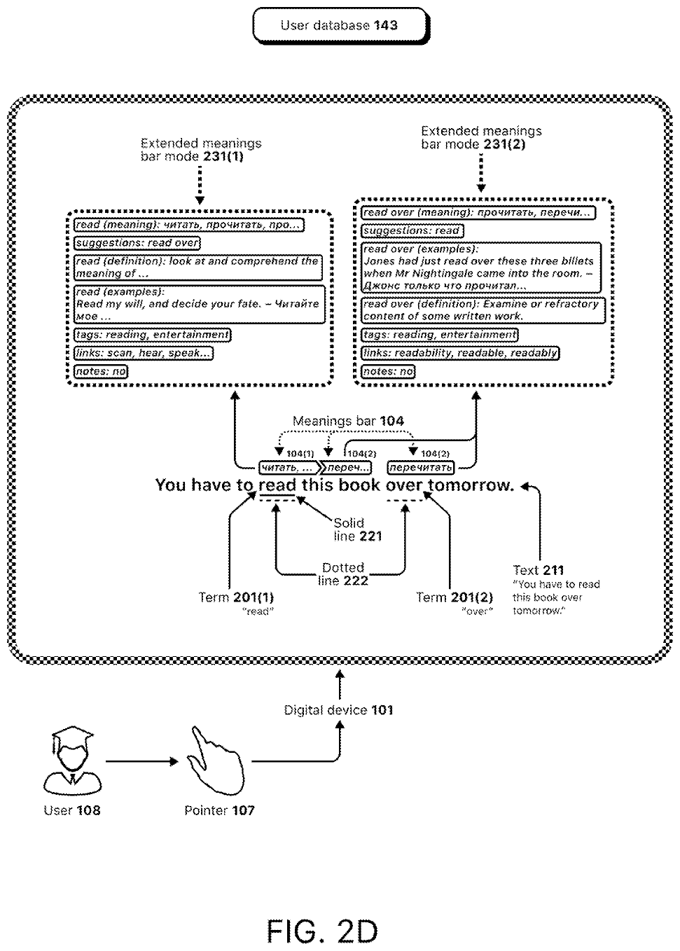

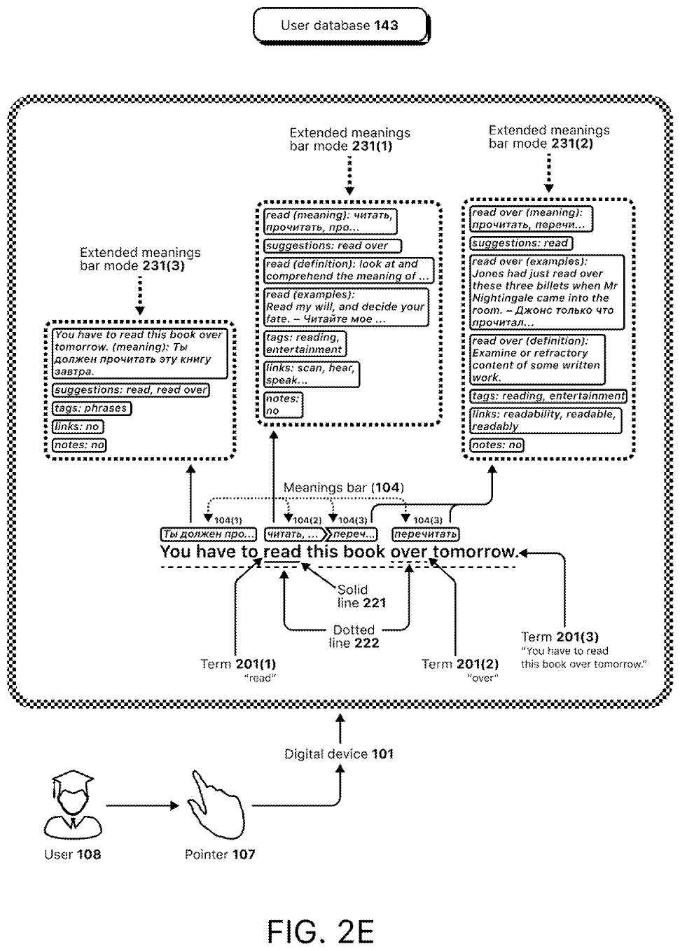

The list of elements depicted in FIGS. 2A-2E is as follows:

The digital device 101 is a computer or mobile device with a display.

The meanings bar 104, 104(1), 104(2), 104(3) is an interactive panel with text or other symbols that can appear above any term in the text and the main task of which is to provide explanatory information for unfamiliar terms in the text in the native or non-native language, definitions for terms in the native or non-native language and other kinds of information related to the term, which is managed by the user via the multifunctional module 121.

The pointer 107 comprises a human finger, an electronic pen, a stylus, a mouse cursor, or other device utilized by the user for selecting objects or interacting with objects on the display screen of the digital device 101.

The user 108 is a person who utilizes the display to learn and/or read.

The term(s) 201(1), 201(2), 201(3) comprise any word, phrase, or sentence in the text that is selected by the user using the pointer 107 or that which is displayed as a copy in the multifunctional module 121. Specifically, the term 201(1) is a single word term, the term 201(2) is also a single word term but is referenced only in connection with the term 201(1) to form a multi-word term (i.e., a phrase), and the term 201(3) is a full sentence term (i.e., a term which comprises an entire sentence).

Text 211 is any kind of electronic text that can be displayed by the digital device 101.

A solid line 221 is a line used to underline single-word terms in the text.

A dotted line 222 is a line used to underline consecutive or non-consecutive multi-word terms, including full sentences, in the text.

The extended meanings bar mode 231(1), 231(2), 231(3) comprises a display mode that is provided when the user interacts with a meanings bar 104 using the pointer 107. The extended meanings bar mode allows for quick access to additional information relating to the term. The extended meanings bar mode comprises an array of independent bars 232 which comprise individual interactive panels carrying additional information.

The meanings bar 104, which is shown in FIG. 2A, is not just text that shows the meanings above the unknown term 201(1) in the text 211. Instead, the meanings bar 104 comprises an interactive element of the display having different content display modes. The meanings bar may thus work as a button through which the user requests the display of the extended meanings bar mode 231(1). FIG. 2B shows what the extended meanings bar mode 231(1) display looks like after the user taps or otherwise interacts with the meanings bar 104 shown in FIG. 2A. The extended meanings bar mode 231(1) replaces the meanings bar 104 and may appear in various areas of the digital display 101 depending on the location of the unknown terms in the text and other meanings bars. The extended meanings bar mode 231(1) is the concentration of all the information that the user 108 might add to the unfamiliar term 201(1) by using the multifunctional module 121, as discussed above and as shown in FIGS. 1A and 1B.

The extended meanings bar mode 231(1) comprises separate independent bars 232. Each of these independent bars can be interacted with using the pointer 107 for even more information. The independent bars 232 do not have a clear structure for displaying information, as they are completely dependent on the data managed by the user via the multifunctional module 121. The extended meanings bar mode 231(1) can be edited using the multifunctional module 121 to restructure the information displayed. Editing the meanings bar 104 may comprise a complete or partial change in information, adding new information, deleting information, changing the order of the meanings of terms within the bar, or changing the meaning of the meanings themselves. The meanings bar 104 will modify its external shape and internal structure depending on its display location in the text and the display location of other meanings bars. If the meanings bar 104 cannot display all the information for the selected term 201(1) due to the technical capabilities of the digital device 101, then the information inside the meanings bar 104 may shrink, scroll horizontally or vertically in different directions, and the meanings bar 104 itself may take on different shapes or colors, decrease or increase in size, or split or merge with other meanings bars in the text depending on the parameters of the text 211, such as: text width, letter size, line spacing, term size, number of terms, and location of terms. The extended meanings bar mode 231(1) can provide combined information about several terms at once, e.g., if the term selected in the text has several meanings because it is part of a multi-word construction, as described below.

FIGS. 2A, 2B, 2C, 2D and 2E illustrate a continuous logical relationship of underlines, which comprise a solid line 221 and/or a dotted line 222 below selected terms. The meanings bar(s) 104 is located above the selected terms in this example. FIGS. 2A-2E also show different ways to display the meanings bar 104 depending on the complexity of the terms in the text. Underlines comprising a solid line 221 and/or a dotted line 222 allow the user to visually navigate when studying unfamiliar terms in the text. Each type of underline has its own logical rules that are used by the software to compile data within the meanings bars 104.

FIG. 2A illustrates, for example, the term 201(1), which is selected in the text 211 and added to the database 143 as a single word term, “read.” Therefore, a meanings bar 104 will appear above the term 201(1) and, in this case, it will be underlined by a solid line 221. That is, underlining with a solid line only one term 201(1) makes it clear to the user that the meanings bar 104 applies only to the single word term 201(1). As shown in FIG. 2B, if the pointer 107 is used to select the meanings bar 104, the user will access the extended meanings bar mode 231(1) for the single word term 201(1).

FIG. 2C illustrates, for example, the selection of a multi-word term, “read over,” consisting of two single word terms 201(1) and 201(2), which are selected as a group within the text 211 and added to the user database 143. As shown in this example, the two terms 201(1) and 201(2) may be separated by other terms but represent a single construct and not individual terms. Multiple terms that are part of a single construct may be next to each other or in different parts of the same sentence. Since the term, “read over,” consists of more than one word such a case will have a dotted underline 222 below each of the related terms. The dotted underline 222, in conjunction with the meanings bar 104, thus visually combines these two terms into one multi-word term consisting of two terms 201(1) and 201(2). Because the terms 201(1) and 201(2) represent a single entity, each term will display the same single meanings bar 104. If the pointer 107 is used to select the meanings bar 104 above the word “read,” the display will show the extended meanings bar mode 231(2) for information on the term, “read over.” Similarly, if the user selects the meanings bar 104 above the word “over”, the display will show the same information and extended meanings bar mode.

FIG. 2D illustrates, for example, the term 201(1), which is selected in the text 211 and which is underlined by a solid line 221, similar to that shown in FIG. 2A, since it was added to the user database 143 as a single word. The single word term 201(1) is also underlined by the dotted line 222, which makes it clear that it also forms a separate multi-word term in conjunction with another non-consecutive term 201(2), which is also underlined with the dotted line 222. As a result of such term selection, FIG. 2D exemplifies a display where the diagrams of FIGS. 2A and 2C are essentially combined. In this case, above the term, “read over,” which consists of two terms 201(1) and 201(2), will show two different meanings bar 104 in the text. Specifically, above the term, “read” 201(1), is a meanings bar 104 consisting of two segments 104(1) and 104(2), since the term 201(1) is both a stand-alone term, “read,” and a part of the multi-word term, “read over.” Above the term, “over” 201(2), only the meanings bar 104(2) for the term, “read over,” is displayed, since the term 201(2) is not added to the user database as a single word “over.” If the user selects the meanings bar 104 for the term, “read” 201(1), which consists of two segments 104(1) and 104(2), the display will show two separate extended meanings bar modes 231(1) and 231(2), which will display information for two terms at once, both for the single term, “read,” and for the combined term, “read over.” If the user instead selects the meanings bar 104(2) above the term, “over,” 201(2), the display will show only the extended meanings bar mode 231(2), corresponding to the meanings information only for the term, “read over.”

FIG. 2E illustrates, for example, the full sentence term 201(3), which is added to the user database 143 in the form of an entire sentence, “You have to read this book over tomorrow.” Since the full sentence term 201(3) is a multi-word construction (i.e., the term comprises two or more words in order), it is underlined with a dotted line. The full sentence term 201(3) has its own meanings bar 104(1) located above it, which, when selected, switches to display a combination of three extended meanings bar modes 231(1), 231(2) and 231(3), which will display information for three terms at once, since they are all part of the same entity: “You have to read this book over tomorrow,” “read,” and “read over.” All three extended meanings bars are displayed because the full sentence term 201(3) contains the terms, “read” 201(1) and “read over” 201(2), which have also been added to the user database 143. Above the term, “read” 201(1), there is displayed its own meanings bar 104, which, as mentioned, is divided into two segments 104(2) and 104(3). If selecting this meanings bar, the display instead switches to show the three extended meanings bar modes 231(1)-231(3), which will display information for three terms at once: “read,” “read over,” and for the full sentence. The term, “over” 201(2), in such a scenario, becomes underlined by a double dotted line 222, since it comprises a single entity with the term, “read” 201(1), as well as a separate single entity with the full sentence term 201(3). If selecting the meanings bar 104(3) above the term, “over” 201(2), the display switches instead to a combination of two extended meaning bar modes 231(2) and 231(3), which will display information for two terms at once, for the multi-word term, “read over”, and for the full sentence.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. An electronic text display, comprising:
a digital device comprising a screen,
a text comprising a set of words displayed on said screen, wherein a user selects a term comprising one or more words from said text,
a multifunctional module for managing a meanings bar, said meanings bar comprising a display of explanatory information for said selected term, said meanings bar being displayed within said text, said multifunctional module being displayed automatically within said screen upon said user selecting said term,
said multifunctional module displaying data relating to said term, said data comprising:
a selectable copy of said one or more selected terms,
one or more selectable meanings for said one or more selected terms,
one or more selectable suggested terms related in morphology to said one or more selected terms,
a toolbar for including additional data relating to said one or more selected terms, and
a multifunctional button for linking user-selected data from said multifunctional module to a user database,
said meanings bar displaying said user-selected data from said multifunctional module via said user database.

2. The electronic text display of claim 1, further comprising a view button, said view button providing for the display or removal of said meanings bar within said text.

3. The electronic text display of claim 1, wherein said multifunctional button comprises three dependent displays, comprising:
a learn button, said learn button providing for a sending of said user-selected data to said user database and thereby to said meanings bar,
a learned button, said learned button causing said user-selected data to become unselected, thereby removing said meanings bar, and
a re-learn button, said re-learn button causing all of said one or more selectable meanings for said one or more selected terms to become selected, thereby re-displaying said meanings bar.

4. The electronic display of claim 1, wherein said toolbar comprises a tags button, a links button, a notes button, a pics button, a video button, and an audio button.

5. The electronic display of claim 1, further comprising an extended meanings bar mode, said extended meanings bar mode displaying an extended meanings window when said user selects said meanings bar, said extended meanings window displaying all user-selected data from said multifunctional module.

6. The electronic display of claim 5, wherein said extended meanings window comprises independent bars.

7. The electronic display of claim 1, wherein said user selects two or more sets of one or more words from said text and wherein said text comprises two or more meanings bars corresponding to each of said two or more sets.

8. The electronic display of claim 7, wherein a first set of said two or more sets is underlined with a solid line and wherein a second set of said two or more sets is underlined with a dotted line.

9. The electronic display of claim 7, wherein all sets of said two or more sets comprising a single word term are underlined with a solid line.

10. The electronic display of claim 7, wherein all sets of said two or more sets consisting of one word are underlined with a solid line.

11. The electronic display of claim 7, wherein all sets of said two or more sets comprising multiple words are underlined with a dotted line.

12. The electronic display of claim 7, wherein all sets of said two or more sets comprising a full sentence are underlined with a dotted line.

13. The electronic display of claim 7, further comprising two or more extended meanings bars.

14. The electronic display of claim 1, wherein said digital device is a computer or a mobile device.

15. The electronic display of claim 1, wherein said screen is a touch screen.

16. The electronic display of claim 1, wherein said screen is a laser-sensing screen.

17. The electronic display of claim 1, wherein said screen comprises a gesture reader system.

18. The electronic display of claim 1, wherein said screen comprises a virtual reality system.

19. The electronic display of claim 1, wherein said meanings bar varies its shape and color, decreases or increases in size, and splits from or merges with other interactive zones of said screen depending on one or more parameters of said text.

20. The electronic display of claim 1, wherein said data displayed in said multifunctional module is resizable and scrollable.
